(19) United States
(12) Patent Application Publication
(10) Pub. No.: US 2013/0108928 A1
(43) Pub. Date: May 2, 2013

(54) LITHIUM-TITANIUM COMPLEX OXIDE AND MANUFACTURING METHOD THEREOF, AS WELL AS BATTERY ELECTRODE AND LITHIUM ION SECONDARY BATTERY USING SAME

(71) Applicant: TAIYO YUDEN CO., LTD., Tokyo (JP)

(72) Inventors: Daigo ITO, Takasaki-shi (JP); Chie KAWAMURA, Takasaki-shi (JP); Masaki MOCHIGI, Takasaki-shi (JP); Akitoshi WAGAWA, Takasaki-shi (JP); Toshiyuki OCHIAI, Takasaki-shi (JP); Isao TAKAHASHI, Takasaki-shi (JP); Yoichiro OGATA, Takasaki-shi (JP); Toshimasa SUZUKI, Takasaki-shi (JP)

(73) Assignee: TAIYO YUDEN CO., LTD., Tokyo (JP)

(21) Appl. No.: 13/654,174

(22) Filed: Oct. 17, 2012

(30) Foreign Application Priority Data
Nov. 2, 2011 (JP) 2011-241736

(51) Int. Cl. H01M 4/485; C01G 23/04

(52) U.S. Cl. 429/231.1; 423/598; 428/402

(57) ABSTRACT

A lithium-titanium complex oxide manufactured by the solid phase method is suitable as an active material for a lithium ion secondary battery. The lithium-titanium complex oxide is characterized in that (a) the average particle size D50 based on granularity distribution measurement by the laser diffraction method is 0.5 to 1.0 μm; (b) the maximum particle size D100 based on granularity distribution measurement by the laser diffraction method and maximum primary particle size d100 measured by observation using a scanning electron microscope have a ratio D100/d100 of 1.5 to 15; and (c) the equivalent sphere size DBET calculated from the specific surface area measured by the BET method and above D50 have a ratio D50/DBET of 3 to 7, and preferably the angle of repose is 35 to 50°.

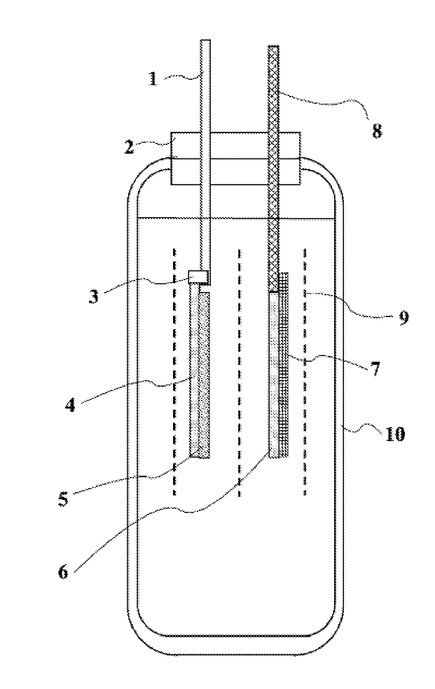

### BACKGROUND

1. Field of the Invention

The present invention relates to a lithium ion secondary battery and electrode thereof and lithium-titanium complex oxide suitable as an electrode material, as well as a manufacturing method thereof.

2. Description of the Related Art

Development of lithium ion secondary batteries as high-capacity energy devices has been active in recent years, and lithium ion secondary batteries are beginning to be utilized in consumer equipment, industrial machinery, automobiles and various other fields. Characteristics required of lithium ion secondary batteries include high energy density, high power density and other characteristics that support high capacity and allow for quick charge/discharge. On the other hand, incidents of fire involving lithium ion secondary batteries have been reported and the market is demanding greater safety of lithium ion secondary batteries. In particular, lithium ion secondary batteries used in onboard applications, medical applications, etc., directly affect human life in case of accidents and require even greater safety. Safety is also required of materials used for lithium ion secondary batteries, where, specifically, the market is demanding materials that demonstrate stable charge/discharge behaviors and will not burst or ignite even in unforeseen accidents.

Lithium titanates include those expressed by Li₄Ti₅O₁₂, Li_{4/3}Ti_{5/3}O₄ and Li[Li_{1/6}Ti_{5/6}]₂O₄, for example. Among these, Li₄Ti₅O₁₂ is a lithium titanate having a spinel crystalline structure. This lithium titanate changes to a rock-salt crystalline structure as lithium ions are inserted during charge, and changes back to a spinel crystalline structure as lithium ions dissociate. The lithium titanate undergoes far less change in its lattice volume due to charge/discharge compared to carbon materials that are conventional materials for negative electrodes, and generates little heat even when shorted to the positive electrode, thereby preventing fire accidents and ensuring high safety. Lithium-titanium complex oxides whose main constituent is lithium titanate and to which trace constituents have been added as necessary, are beginning to be adopted by lithium ion secondary battery products that are designed with specific focus on safety.

Tap density of powder, which is traditionally evaluated as one general powder property required of battery materials including lithium-titanium complex oxides, is an important factor that affects handling of powder and becomes particularly useful when the sizes of primary particles constituting the powder are relatively large in a range of several μm to several tens of μm or when an electrode coating film is formed directly from the granulated powder. On the other hand, powder properties of lithium ion secondary battery materials are drawing renewed attention in recent years in order to support the high-performance needs of lithium ion secondary batteries, and as part of this trend, attempts are being made to reduce the primary particle size of the powder. This is an important factor that affects quick charge/discharge (rate characteristics) as the smaller the particle size, the smoother the insertion/dissociation reactions of lithium ions become, and good characteristics are achieved as a result.

Methods to make the particles constituting the powder finer include the method to use the liquid phase method to make the primary particles themselves fine (build-up method) as described in Patent Literature 1, and the method to crush the primary particles after giving them a relatively rough heat treatment to make them finer (breakdown method) as described in Example 1 of Patent Literature 2. There is also a method, which is not the liquid phase method, whereby a very fine titanium compound is used as the material and mixed with a lithium compound, and then the mixture is heat-treated at low temperature to manufacture fine lithium titanate particles. Patent Literature 3 touches on the particle size distribution measured by laser diffraction and reports that the particle size distribution has positive impact on rate characteristics.

### BACKGROUND ART LITERATURES

[Patent Literature 1] Japanese Patent No. 3894614

[Patent Literature 1] Japanese Patent Laid-open No. 2002-289194

[Patent Literature 1] Japanese Patent No. 4153192

### SUMMARY

Patent Literatures 1 and 2 each describe a powder design that allows for easy handling in a specific application, but neither discloses a clear powder design method for effectively handling fine particles. Patent Literature 3 stops at disclosing the particle size distribution in the forms of average size and distribution band of secondary particles, but this information alone does not clearly reveal the average size and distribution band of primary particles. There is no mention of properties of coating solution and coating film, either. Here, it should be noted that the primary particle size and secondary particle size are differentiated. Furthermore, the primary particle size distribution and secondary particle size distribution can each be an equally important factor. The primary particle refers to the smallest unit of particle constituting the powder, while the secondary particle refers to an aggregate formed by a group of primary particles.

If the particle size is too small, the ease of handling is affected, for example, dispersion becomes difficult when preparing an electrode coating solution or the like. If an electrode coating film is formed from fine particles, the electrode density cannot be raised, unlike when it is formed from large particles as has been done traditionally. This is because, when an electrode coating solution is prepared, fine particles do not disperse stably in the dispersion medium and end up forming a three-dimensional cross-linked structure. When large particles are used, the tap filling property of the powder is somewhat correlated with the density of the coating film, but when fine particles are used, the wettability on the particle surface and affinity with the dispersion medium tend to drop in the coating solution, and cohesion and formation of cross-linked structure occur easily as a result, which is different from the tap filling property exhibited by the powder. If an electrode coating film is formed using the above coating solution, the coating film density drops and consequently the energy density of the lithium ion secondary battery obtained becomes lower and other problems may also occur, such as drop in reliability due to separation of the film. To prevent these problems, additives such as a large amount of binder and the like must be used. It is important to properly handle a powder made of fine particles that tend to exhibit good rate characteristics, by using the same amount of binder as before.

In addition, superfine particles whose particle size distribution as measured by laser diffraction is 0.2 μm or less are generally difficult to trap due partly to problems regarding the measurement principles and partly to the fact that these particles cohere relatively easily in the dispersion medium, where the tendency is that the finer the overall particle size, the lower the reliability becomes. In other words, fine particles whose average particle size is 1 μm or less cannot clearly express, through powder evaluation by laser diffraction measurement alone, the powder properties needed to exhibit optimal battery characteristics. Prior arts do not present any powder design that optimizes the dispersion stability in the electrode coating solution, ease of handling, and electrode coating film density, while at the same time most benefiting the battery characteristics such as rate characteristics and the like.

Any discussion of problems and solutions involved in the related art has been included in this disclosure solely for the purposes of providing a context for the present invention, and should not be taken as an admission that any or all of the discussion were known at the time the invention was made.

In consideration of the above, the object of the present invention is to provide a lithium titanate for manufacturing batteries that can be manufactured by the solid phase method associated with low manufacturing cost, and which allows for use of fine particles, facilitates management in the manufacturing process, and eases handling in manufacturing electrodes and exhibits high rate characteristics.

To determine in a more comprehensive manner the granularity of the powder having a fine particle size of 1 μm or less, the inventors of the present invention conducted multi-faceted evaluations, including laser diffraction measurement to evaluate the overall granularity distribution (secondary particle size distribution) that contributes to the macro properties of the powder, measurement of BET specific surface area to accurately determine the difference attributable to the super-fineness of particles, and observation using a scanning electron microscope (SEM) to evaluate coarse particles, etc. Through these multi-faceted evaluations, carried out from the viewpoint of revealing a most suitable powder design in terms of battery characteristics, the inventors completed the invention described below.

The present invention provides a lithium-titanium complex oxide, wherein: (a) the average particle size D50 based on granularity distribution measurement by the laser diffraction method is 0.5 to 1.0 μm; (b) the maximum particle size D100 based on granularity distribution measurement by the laser diffraction method and maximum primary particle size d100 measured by observation using a scanning electron microscope have a ratio D100/d100 of 1.5 to 15; and (c) the equivalent sphere size DBET calculated from the specific surface area measured by the BET method and above D50 have a ratio D50/DBET of 3 to 7. Preferably the angle of repose of such lithium-titanium complex oxide is 35 to 50°.

The present invention provides a positive electrode for a battery or negative electrode for a battery that contains the aforementioned lithium-titanium complex oxide as an active material. A lithium-ion secondary battery having such positive electrode and negative electrode is also an embodiment of the present invention.

According to the manufacturing method of lithium-titanium complex oxide proposed by the present invention, a mixture of titanium compound and lithium compound is heat-treated at 700° C. or above to obtain a lithium-titanium complex oxide, after which 100 parts by weight of the obtained lithium-titanium complex oxide powder is crushed in the presence of 10 parts by weight or less of dispersion medium to increase the specific surface area of the lithium-titanium complex oxide by 5.0 m²/g or more, and preferably the lithium-titanium complex oxide is heat-treated again to decrease its specific surface area by 0.5 to 6.0 m²/g.

According to the present invention, the average particle sizes of both primary and secondary particles can be reduced by dry crushing, without having to convert into a slurry the lithium-titanium complex oxide obtained by heat treatment. At this time, potential re-cohesion is controlled to control the amount of fine particles and size distribution of secondary particles. Thus obtained, the lithium-titanium complex oxide proposed by the present invention has sufficiently fine primary particles and therefore tends to express desired rate characteristics. In addition, its viscosity can be kept sufficiently low to allow for coating, even if the primary particle size is fine and even if the amount of dispersion medium used in the prepared electrode coating solution is small, with the coating film formed by the coating solution having high density and also offering high separation strength without having to increase the amount of binder.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description which follows.

### BRIEF DESCRIPTION OF THE DRAWINGS

These and other features of this invention will now be described with reference to the drawing of a preferred embodiment which is intended to illustrate and not to limit the invention. The drawing is greatly simplified for illustrative purposes and is not necessarily to scale.

The FIGURE is a schematic section view of a half cell.

### DESCRIPTION OF THE SYMBOLS

1,8 Al lead

2 Thermo-compression bonding tape

3 Kapton tape

4 Aluminum foil

5, 15, 16 Electrode mixture

6 Metal Li plate

7 Ni mesh

9 Separator

10 Aluminum laminate cell

### DETAILED DESCRIPTION OF EMBODIMENTS

According to the present invention, a ceramic material whose main constituent is a lithium titanate having a spinel structure expressed by Li₄Ti₅O₁₂ and to which trace constituents have been added as necessary is provided, and this ceramic material contains the aforementioned lithium titanate typically by 90% or more, or preferably 95% or more. In this Specification, this ceramic material is sometimes referred to as “lithium-titanium complex oxide.” According to the present invention, the lithium-titanium complex oxide is in a powder form as an aggregate of particles whose shape (particle size distribution, etc.) is explained in detail below. According to the present invention, the lithium-titanium complex oxide can contain elements other than titanium, lithium and oxygen, where examples of the elements that can be contained include potassium, phosphorous, niobium, sulfur, silicon, zirconium, calcium and sodium, etc. Preferably these constituents are virtually all dissolved in the ceramic structure of lithium titanate as oxides.

The inventors revealed detailed conditions for particle size distribution and optimal cohesion level as factors that affect the battery characteristics. According to the present invention, the average value (D50) and maximum value (D100) of secondary particle size are important. This is because the overall range of particle size distributions affects the battery characteristics most. D50 is the simplest evaluation standard on which to understand the fineness of a basic particle, where a range associated with good battery characteristics is generally 0.5 to 1.5 μm, while a range associated with both good battery characteristics and rate characteristics is 0.5 to 1.0 μm. D50 and D100 are particle size indicators based on the cumulative frequency by laser diffraction granularity distribution measurement.

Methods to increase D50 include growing the particle by raising the temperature of the heat treatment given to synthesize the lithium-titanium complex oxide (primarily increasing the primary particle size), or adding a cohesion operation after heat-treating and synthesizing the lithium-titanium complex oxide (primarily increasing the secondary particle size), etc, while methods to decrease D50 include suppressing the particle growth by lowering the temperature of the heat treatment at the time of synthesis (primarily decreasing the primary particle size), or adding a crushing operation after heat-treating and synthesizing the lithium-titanium complex oxide (primarily decreasing the secondary particle size), etc.

To determine the factors benefiting the battery characteristics in a comprehensive manner, knowing D50 alone is not sufficient. Here, the equivalent sphere size DBET calculated from the specific surface area measured by the BET method is considered and focused on. Assuming that all particles are spheres of the same size, DBET (μm) is calculated by applying the formula 1.724/S to the specific surface area S (m²/g) measured by the BET method. The constant in this formula considers the specific gravity of the material system used here. According to the present invention, the ratio of D50/DBET is the target of focus. The greater the number of fine particles contained, the higher this ratio becomes. In other words, this ratio can be interpreted as the degree (aggregation level) to which the secondary particle size is greater than the actual primary particle size. On the other hand, the inverse of this ratio, or DBET/D50, can be interpreted as the fineness. Since the aggregation level focuses on fine particles, it is called the “fine powder aggregation level” as a matter of convenience. According to the present invention, the fine powder aggregation level D50/DBET is 3 to 7, or preferably 3.5 to 6, if good battery characteristics are to be obtained. The fine powder aggregation level D50/DBET is more accurate because it is not described by laser diffraction measurement alone.

If the fine powder aggregation level D50/DBET is less than 3, the properties of electrode coating solution and electrode coating film tend to worsen. Too small a D50/DBET means a small D50 despite the fact that there are not many very fine particles, which may be explained by these particles being in a state relatively close to mono-dispersion. Probably when many fine particles not forming an aggregate are dispersed in the dispersant, they tend to form a three-dimensional network in the dispersant, and consequently the dispersion stability of coating solution tends to drop. To ensure dispersion stability, or increase the strength of coating film, a method to increase the amount of dispersant or binder used must beused. An extremely high DBET, or specifically coarse primary particle formed, results in too small a D50/DBET, in which case the rate characteristics drop significantly.

When the fine powder aggregation level D50/DBET exceeds 7, the stability of electrode coating solution may drop, the required amount of dispersant or binder will increase, or cycle characteristics may worsen. A possible explanation for the above is that presence of many very fine particles results in an excessively large specific surface area of the powder, which causes the required amount of dispersant or binder to increase and promotes the reaction with the electrolyte solution in the battery, leading to a shorter life. If an excessive D50 results in a D50/DBET of over 7, which is a condition outside the scope of the present invention, good properties of coating solution and electrode coating film are likely achieved, but rate characteristics are not expressed easily, which is inappropriate.

Methods to raise the ratio of D50/DBET include, in addition to the aforementioned means for raising the D50, increasing the specific surface area by suppressing the growth of particles by lowering the heat treatment temperature applied when a lithium-titanium complex oxide is synthesized, or by crushing the synthesized lithium-titanium complex oxide, etc. Methods to lower the ratio of D50/DBET include, in addition to the aforementioned means for lowering the D50, decreasing the specific surface area by promoting the growth of particles by raising the heat treatment temperature applied when a lithium-titanium complex oxide is synthesized, by lowering the crushing intensity of the synthesized lithium-titanium complex oxide, or by not crushing the lithium-titanium complex oxide, etc.

The inventors of the present invention also focused on the primary particle size d100 measured by observation using a scanning electron microscope. In a sample system whose granularities are distributed over fine levels, it is practically impossible to obtain the d100 by laser diffraction measurement as this type of measurement is affected by the aggregate. Accordingly, the size of the coarsest primary particle among all particles observed is obtained using a scanning electron microscope (SEM). d100 measurement by SEM observation is carried out by the method explained below. Specifically, the powder to be measured is pressed at 20 kgf/cm² using a press machine to prepare a pelletized sample. This sample is fixed on a SEM sample base using an acrylic resin in which carbon black particles are dispersed, after which the sample is dried at 150° C. and Pt is deposited. Ten images of particles are taken at desired locations using a scanning electron microscope set to ×10000 magnifications. Particle sizes are measured by obtaining the feret diameter of each particle. To be specific, an average of a total of four sides including two sides of a rectangle circumscribing the particle image and two sides of a rectangle circumscribing the same particle image tilted by 45 degrees, is calculated and used as the size of the observed particle. Following this method, largest particle sizes are identified in each image and an average d100 of the ten largest sizes is calculated. Preferably the d100 is 1 to 3 μm.

According to the present invention, the ratio of D100 and d100 mentioned above, or D100/d100, is 1.5 to 15, or preferably 1.5 to 12, or more preferably 2 to 10, if good battery characteristics are to be obtained. While the D50/DBET mentioned earlier represents the degree of aggregation of fine powder, the ratio D100/d100 represents the degree of aggregation of coarse powder (coarse powder aggregation level).

A coarse powder aggregation level D100/d100 of less than 1.5 means that the d100 is too large and/or D100 is too small. Too large a d100 causes the rate characteristics to worsen more prominently, while too small a D100 increases the required amount of dispersant or binder when the coating solution is prepared, thus causing the density of electrode coating film to drop more easily. This is because too large a d100 leads to too many coarse primary particles, while a small D100 creates a so-called excessively dispersed state, close to mono-dispersion, overall. If the coarse powder aggregation level D100/d100 is excessive, obtaining a uniform coating film becomes difficult. This is because the tendency of excessive aggregation causes the properties of electrode coating film to worsen and both the density and strength to drop, which in turn increases the peeling of film and capacity variation and worsens the cycle characteristics.

Methods to raise the ratio of D100/d100 include lowering the d100 by suppressing the growth of particles by lowering the heat treatment temperature applied when a lithium-titanium complex oxide is synthesized or by crushing the synthesized lithium-titanium complex oxide, or increasing the D100 by inducing aggregation while or after the synthesized lithium-titanium complex oxide is crushed. Methods to lower the ratio of D100/d100 include increasing the d100 by promoting the growth of particles by raising the heat treatment temperature applied when a lithium-titanium complex oxide is synthesized or by lowering the crushing intensity of the synthesized lithium-titanium complex oxide or by not crushing the lithium-titanium complex oxide, etc., or lowering the D100 by not inducing aggregation while or after the synthesized lithium-titanium complex oxide is crushed, etc.

According to the present invention, a key point of design is to cause particles of relatively large secondary particle sizes to be present at a specified frequency. The best mode is where fine primary particles are cohered to some extent and where the percentage accounted for by this aggregate is not too high. In other words, by causing groups of secondary particles to be present beforehand, they can be stably dispersed in the coating solution dispersion medium by keeping the amounts of required dispersion medium and binder low, and the coating film obtained from the resulting coating solution exhibits high density and high strength. This can be explained by the aggregate reinforcing the coating film by acting like a filler on the macro-level. The balance of secondary particle size and primary particle size is also important, where if the secondary particle size is too large, the coating film thickness cannot be reduced and surface smoothness also deteriorates. If the primary particles are too small, controlling the formation of aggregate becomes difficult. It is important to control the balance of primary size and secondary size and if too many fine particles are produced as a result of crushing the primary particles too fine, implementing proper controls in the powder state and preparation of coating solution becomes difficult.

In addition, the angle of repose is important in ensuring ease of handling when convenience in actual applications is considered. The angle of repose refers to the angle formed by the plane and ridgeline of powder when the powder is deposited on the plane. Under the present invention, the angle of repose measured according to the angle-of-repose measurement method specified in JIS R9301-2-2: 1999 is preferably 30 to 50°, or more preferably 35 to 50°. A powder having an angle of repose in these ranges is easy to handle as it does not clog easily and maintains appropriate flowability. Processes to increase the angle of repose include reducing the particle size via crushing, narrowing the particle size distribution band via classification operation, and giving the secondary particles an irregular form, etc, while processes to decrease the angle of repose include increasing the particle size and widening the particle size distribution band via cohesion operation and making the secondary particles spherical, etc.

The method to manufacture the lithium-titanium complex oxide proposed by the present invention is not specifically limited, and the favorable example given below is only an example. The lithium-titanium complex oxide is generally manufactured through a step to mix the materials uniformly, a step to heat-treat the obtained mixture, and step to crush the lithium-titanium complex oxide obtained by heat treatment if it is coarse.

Under the solid phase method, lithium-titanium complex oxide is typically obtained by mixing and sintering a titanium compound, lithium compound, and trace constituents, as necessary.

For the lithium source, a lithium salt or lithium hydroxide is typically used. Examples of the lithium salt include a carbonate and acetate, etc. As a hydroxide, a hydrate such as monohydrate or the like may be used. For the lithium source, two or more of the foregoing may be combined. As other lithium materials, lithium compounds that are generally readily available can be used as deemed appropriate. If residues of substances originating from the lithium compound cannot be permitted in the heat treatment process, it is safe to avoid lithium compounds containing elements other than C, H and O. For the titanium source, a titanium dioxide or hydrous titanium oxide can be applied. A lithium compound is mixed with a titanium compound by the wet method or dry method so that the mol ratio of Li and Ti preferably becomes 4:5. It should be noted that, since lithium may decrease as a result of partial volatilization, loss due to sticking to equipment walls, or for other reasons in the manufacturing process, a greater amount of source lithium than the final target amount of Li may be used.

Wet mixing is a method whereby dispersion medium such as water, ethanol or the like is used together with a ball mill, planetary ball mill, bead mill, wet jet mill, etc. Dry mixing is a method whereby no dispersion medium is used and a ball mill, planetary ball mill, bead mill, jet mill or flow-type mixer, or Nobilta (Hosokawa Micron), Miralo (Nara Machinery) or other machine capable of applying compressive force or shearing force to achieve precision mixing or efficiently add mechano-chemical effect, is used, etc.

The mixed materials are heat-treated in atmosphere, dry air, nitrogen, argon or other atmosphere at 700° C. or above, or preferably at 750 to 950° C., to obtain a lithium-titanium complex oxide. The specific heat treatment temperature changes as deemed appropriate according to the particle sizes and mixing level of materials as well as the target particle size of the lithium-titanium complex oxide.

In general, a lithium-titanium complex oxide obtained through heat treatment at 700° C. or above has relatively large primary particles and often its primary particles are cohered together. In this case, particle properties in optimal ranges can be achieved easily when relatively high energy is applied during the crushing process. Such lithium-titanium complex oxide before crushing has a specific surface area of preferably 0.5 to 5 m²/g, or more preferably 1 to 3 m²/g. The value of this specific surface area can be lowered by raising the heat treatment temperature or extending the heat treatment time. The value of specific surface area can be raised by lowering the heat treatment temperature or shortening the heat treatment time to the extent that the synthetic reaction of lithium-titanium complex oxide still takes place. Optimal particles can be obtained easily by adjusting the increase in specific surface area after crushing to 1.0 m²/g or more, or preferably 5.0 m²/g or more, more preferably, within a range of 6.0 to 13.0 m²/g. Preferably 100 parts by weight of the lithium-titanium complex oxide obtained through the aforementioned heat treatment is crushed in the presence of 10 parts by weight or less of dispersion medium. The value of specific surface area after crushing can be raised by extending the crushing time, or it can be lowered by shortening the crushing time.

Next, cohesion is preferably designed. The approach here is to add a cohesion process under specific conditions after crushing the lithium-titanium complex oxide and designing its primary particles and secondary particles fine. Methods used for the cohesion process include partially necking the particles via heat treatment at approx. 300 to 700° C., temperatures lower than the range used in the heat treatment for synthesizing the lithium-titanium complex oxide (hereinafter also referred to as the “second heat treatment”), or promoting cross-attachment/cohesion of powder particles using any of various powder processing apparatuses, etc.

To achieve cohesion at the time of crushing in a powder treatment apparatus, achieving a proper cohesion design is difficult if a jet mill or other apparatus where the powder does not easily make direct contact with the apparatus is used, and apparatus having a classification mechanism such as a classification rotor and the like are not suitable. However, this is not the case if a re-cohesion step is provided after crushing. In addition, an organic solvent, etc. offers the effect of promoting crushing as additive auxiliary and can also be used as a cohesion agent for partially cohering the powder. For example, it is possible to maintain an aggregate of a certain size or smaller, even when a powder equipment aimed at crushing through a grinding process, etc., is used, by effectively utilizing auxiliaries. The particle size of the aggregate changes depending on the types of auxiliaries. However, desirably the additive quantities of auxiliaries are kept to 10 percent by weight or less, or preferably 5 percent by weight or less, or more preferably 2 percent by weight or less, relative to the powder. Effects of auxiliaries include improving the powder crushing efficiency and forming an aggregate. In particular, their aggregate-forming effect is very important in achieving an optimal powder design. The best mode of the present invention is achieved by combining the above powder crushing process, aggregate-formation process and low-temperature heat treatment (second heat treatment). By adjusting the particle size distribution of the powder following the synthesis of lithium-titanium complex oxide and then heat-treating again the powder whose particle size distribution has thus been adjusted, separation can be minimized when a coating solution is prepared, coating film is formed or pressed, etc., and also the powder can be handled easily without causing its particle size distribution to change even when the powder receives compressive stress due to its dead weight inside a flexible bulk container during transit.

When the second heat treatment is given, the specific surface area of the lithium-titanium complex oxide to be heat-treated again is preferably 7 to 18 m²/g, or more preferably 8 to 15 m²/g. The value of specific surface area after the second heat treatment can be lowered by raising the temperature of the second heat treatment or extending the heat treatment time. To raise the value of specific surface area, the temperature of the second heat treatment can be lowered or second heat treatment time can be shortened. The decrease in the specific surface area of the lithium-titanium complex oxide due to second heat treatment is preferably 0.5 to 6.0 m²/g.

Although the solid phase method discussed above is advantageous in terms of cost among the manufacturing methods for lithium-titanium complex oxide, the sol-gel method or liquid phase method using alkoxide, etc. can also be adopted.

The lithium-titanium complex oxide proposed by the present invention can be used favorably as an active electrode material for lithium ion secondary batteries. It can be used for positive electrodes and negative electrodes. The configurations and manufacturing methods of electrodes containing the lithium-titanium complex oxide as their active material and lithium ion secondary battery having such electrodes can apply any prior technology as deemed appropriate. Also in the examples explained later, an example of manufacturing a lithium ion secondary battery is presented. Typically an electrode coating solution containing the lithium-titanium complex oxide as an active material, conductive auxiliary, binder, and solvent is prepared and this electrode coating solution is applied to the metal piece, etc., and dried, and then pressed to form an electrode. Examples of the conductive auxiliary include acetylene black, examples of the binder include various resins, or fluororesin, etc., to be more specific, and examples of the solvent include n-methyl-2-pyrrolidone, etc. A lithium ion secondary battery can be constituted by the electrodes thus obtained, electrolyte solution containing lithium salt, separator, and the like.

### EXAMPLES

The present invention is explained more specifically using examples. It should be noted, however, that the present invention is not limited to the embodiments described in these examples. First, how the samples obtained by the examples/comparative examples were analyzed and evaluated is explained.

(How to Measure D50, D100, etc.)

D50 and D100 are particle size indicators based on cumulative frequency by laser diffraction measurement of particle size distribution. D50 represents the particle size when the cumulative frequency as counted from the smallest particle size reaches 50%, while D100 represents the particle size when the cumulative frequency reaches 100%. The Microtrack HRA9320-X100 by Nikkiso was used as a measurement apparatus, ethanol was used as a dispersion medium, and samples were dispersed by supersonic waves for 3 minutes using a supersonic homogenizer as a pretreatment.

(Measurement of Specific Surface Area)

The specific surface area was measured using the FlowSorb II-2300 by Shimadzu.

(Observation Using a Scanning Electron Microscope)

As for observation using a scanning electron microscope, the high-resolution field-emission scanning electron microscope S-4800 by Hitachi was used to capture two-dimensional electron images at an acceleration voltage of 5 kV, and feret diameters were obtained from the images.

(Measurement of Angle of Repose)

The angle of repose was measured according to JIS R9301-2-2: 1999.

(Battery Evaluation—Half Cell)

The figure is a schematic section view of a half cell. An electrode mixture was prepared by using lithium-titanium complex oxide as an active material. Ninety parts by weight of the obtained lithium-titanium complex oxide as an active material, 5 parts by weight of acetylene black as a conductive auxiliary, and 5 parts by weight of polyvinylidene difluoride (PVdF) as a binder, were mixed using n-methyl-2-pyrrolidone (NMP) as a solvent (dispersion medium). The materials were mixed using a high-shear mixer until a stable viscosity was obtained. The amount of NMP was adjusted so the viscosity of the mixed coating solution fell under a range of 500 to 1000 mPa·sec at 100 s⁻¹, and the amount required (weight ratio relative to 1 part by weight of solid content) was recorded. This electrode mixture 5 was applied to an aluminum foil 4 to a coating weight of 3 mg/cm² using the doctor blade method. The coated foil was vacuum-dried at 130° C., and then roll-pressed. The corresponding coating film density was calculated from the film thickness and coating weight, and recorded. The coating film was subjected to a peel test using a commercially available clear adhesive tape, with the test repeated five times at one location. The test results were classified into [symbol] (no peeling), ◯ (neither z,25 nor ×) and × (peeling of 30% or more), and recorded. The coating film was also visually observed for smoothness and the results were classified into z,25 (no visible surface irregularity or irregular surface pattern), ◯ (neither z,25 nor ×) and × (3 or more surface irregularities or irregular surface pattern per 100 mm²), and recorded. An area of 10 cm² was stamped out from the coating film to obtain a positive electrode. For the negative electrode, a metal Li plate 6 attached to a Ni mesh 7 was used. For the electrolyte solution, ethylene carbonate and diethyl carbonate were mixed at a volume ratio of 1:2, and then 1 mol/L of LiPF₆ was dissolved into the obtained solvent. For a separator 9, a porous cellulose membrane was used. Also, as illustrated, Al leads 1, 8 were fixed using a thermo-compression bonding tape 2, and the Al lead 1 was fixed to the working electrode using a Kapton tape 3. An aluminum laminate cell 10 was thus prepared. This battery was used to measure the initial discharge capacity. The battery was charged to 1.0 V at a constant current of 0.105 mA/cm² (0.2 C) in current density, and then discharged to 3.0 V, with the cycle repeated three times and the discharge capacity in the third cycle used as the value of initial discharge capacity. Next, the rate characteristics were measured. Measurement was performed by increasing the charge/discharge rate in steps from 0.2 C to 1 C, 2 C, 3 C, 5 C and 10 C. The ratio of the discharge capacity at the 10-C rate in the second cycle, to the 0.2-C discharge capacity, was recorded as rate characteristics (%).

### Example 1

Into a 5-L pot, 728 g of a highly pure Anatase-type titanium dioxide of 10 m²/g in specific surface area (primary particle size of approx. 0.15 um) and 272 g of a reagent-grade lithium carbonate of 25 μm in average particle size were introduced and sealed together with 7 kg of zirconium beads of 10 mm in diameter, after which the mixture was agitated for 24 hours at 100 rpm and then separated from the beads to obtain a mixed powder. The mixed powder was filled in a saggar and heat-treated in a continuous sintering furnace in atmosphere under a profile of retaining the maximum temperature of 870° C. for 3 hours. Next, 700 g of this heat-treated powder was introduced to a batch bead mill filled with zirconium beads of 10 mm in diameter and crushed for 25 minutes, after which the crushed powder was passed twice through a pin mill of 250 mm in disk diameter operating at 7000 rpm. Thereafter, the powder was put through a grinding process for 10 minutes using an automatic grinder. Furthermore, a dry classification machine equipped with a classification rotor of 320 mm in diameter was used to classify the crushed powder at a speed of 1500 rpm, after which the portion passing the classification rotor was collected. The obtained powder was filled in a saggar and heat-treated again in a continuous sintering furnace in atmosphere under a profile of retaining the maximum temperature of 590° C. for 3 hours, to obtain a lithium-titanium complex oxide.

### Example 2

A lithium-titanium complex oxide was prepared according to the same method described in Example 1, except that no classification was performed using a classification machine.

### Example 3

A lithium-titanium complex oxide was prepared according to the same method described in Example 1, except that the speed of classification using the classification machine was changed to 5000 rpm.

### Example 4

A lithium-titanium complex oxide was prepared according to the same method described in Example 2, except that the processing time in the batch bead mill was changed to 35 minutes and that 0.5 percent by weight of ethanol relative to the powder was dripped in as an auxiliary when the powder was introduced to the batch bead mill and to the automatic grinder.

### Example 5

A lithium-titanium complex oxide was prepared according to the same method described in Example 4, except that no pin milling was performed.

### Example 6

A lithium-titanium complex oxide was prepared according to the same method described in Example 1, except that the speed of classification using the classification machine was changed to 5500 rpm.

### Examples 7 to 10

A lithium-titanium complex oxide was prepared according to the same method described in Example 1, except that the processing time in the batch bead mill was changed to 45 minutes (Example 7), 10 minutes (Example 8), 80 minutes (Example 9) and 7.5 minutes (Example 10).

### Examples 11, 12

A lithium-titanium complex oxide was prepared according to the same method described in Example 5, except that the processing time in the batch bead mill was changed to 80 minutes (Example 11) and 7.5 minutes (Example 12).

### Comparative Example 1

A lithium-titanium complex oxide was prepared according to the same method described in Example 5, except that no grinding was performed.

### Comparative Example 2

A lithium-titanium complex oxide was prepared according to the same method described in Example 1, except that the speed of classification using the classification machine was changed to 6000 rpm.

### Comparative Examples 3, 4

A lithium-titanium complex oxide was prepared according to the same method described in Example 1, except that the processing time in the batch bead mill was changed to 120 minutes (Comparative Example 3) and 5 minutes (Comparative Example 4).

### Comparative Examples 5, 6

A lithium-titanium complex oxide was prepared according to the same method described in Example 5, except that the processing time in the batch bead mill was changed to 120 minutes (Comparative Example 5) and 5 minutes (Comparative Example 6).

### Comparative Examples 7, 8

A lithium-titanium complex oxide was prepared according to the same method described in Example 1, except that the maximum sintering temperature using the continuous sintering furnace was changed to 970° C. (Comparative Example 7) and 770° C.

### Comparative Example 8

The evaluation results of Examples and Comparative Examples are summarized in Tables 1 to 3.

TABLE 1

| | | | BET | | | | |
|---|---|---|---|---|---|---|---|
| | D50 | D100 | SSA | d100 | D50/ | D100/ | Angle of |
| | μm | μm | m²/g | μm | DBET | d100 | repose ° |
| Example 1 | 0.81 | 7.13 | 10.1 | 1.13 | 4.8 | 6.3 | 40 |
| Example 2 | 0.85 | 11.0 | 9.4 | 1.20 | 4.6 | 9.2 | 38 |
| Example 3 | 0.80 | 2.52 | 10.7 | 1.02 | 5.0 | 2.5 | 44 |
| Example 4 | 0.89 | 13.1 | 9.9 | 1.17 | 5.1 | 11.2 | 37 |
| Example 5 | 0.91 | 18.5 | 9.5 | 1.27 | 5.0 | 14.6 | 37 |
| Example 6 | 0.76 | 1.95 | 10.8 | 1.15 | 4.7 | 1.7 | 45 |
| Example 7 | 0.81 | 6.54 | 12.1 | 1.07 | 5.7 | 6.1 | 41 |
| Example 8 | 0.82 | 7.13 | 7.8 | 1.22 | 3.7 | 5.8 | 39 |
| Example 9 | 0.81 | 6.54 | 14.0 | 1.01 | 6.5 | 6.5 | 43 |
| Example 10 | 0.79 | 7.78 | 6.8 | 1.28 | 3.1 | 6.1 | 38 |
| Example 11 | 0.92 | 15.6 | 12.6 | 1.09 | 6.7 | 14.3 | 36 |
| Example 12 | 0.84 | 20.2 | 6.3 | 1.43 | 3.1 | 14.1 | 38 |
| Comp. Ex. 1 | 0.95 | 20.2 | 8.9 | 1.28 | 4.9 | 15.8 | 35 |
| Comp. Ex. 2 | 0.70 | 1.55 | 11.0 | 1.09 | 4.5 | 1.4 | 49 |
| Comp. Ex. 3 | 0.79 | 6.00 | 15.7 | 0.98 | 7.2 | 6.1 | 46 |
| Comp. Ex. 4 | 0.82 | 7.78 | 5.5 | 1.40 | 2.6 | 5.6 | 36 |
| Comp. Ex. 5 | 0.92 | 14.3 | 13.8 | 1.03 | 7.4 | 13.9 | 36 |
| Comp. Ex. 6 | 0.88 | 24.0 | 4.8 | 1.64 | 2.5 | 14.6 | 36 |
| Comp. Ex. 7 | 1.67 | 7.78 | 7.7 | 3.20 | 7.5 | 2.4 | 38 |
| Comp. Ex. 8 | 0.44 | 7.13 | 10.4 | 0.62 | 2.7 | 11.5 | 47 |

TABLE 2

| | BET SSA after | BET SSA after | BET SSA after second |
|---|---|---|---|
| | heat treatment | crushing | heat treatment |
| | m²/g | m²/g | m²/g |
| Example 1 | 3.1 | 12.0 | 10.1 |
| Example 2 | 3.1 | 11.6 | 9.4 |
| Example 3 | 3.1 | 12.4 | 10.7 |
| Example 4 | 3.1 | 12.5 | 9.9 |
| Example 5 | 3.1 | 12.2 | 9.5 |
| Example 6 | 3.1 | 12.5 | 10.8 |
| Example 7 | 3.1 | 14.2 | 12.1 |
| Example 8 | 3.1 | 9.6 | 7.8 |
| Example 9 | 3.1 | 16.1 | 14.0 |
| Example 10 | 3.1 | 8.4 | 6.8 |
| Example 11 | 3.1 | 14.9 | 12.6 |
| Example 12 | 3.1 | 8.2 | 6.3 |
| Comp. Ex. 1 | 3.1 | 12.1 | 8.9 |
| Comp. Ex. 2 | 3.1 | 12.8 | 11.0 |
| Comp. Ex. 3 | 3.1 | 18.1 | 15.7 |
| Comp. Ex. 4 | 3.1 | 7.0 | 5.5 |
| Comp. Ex. 5 | 3.1 | 16.5 | 13.8 |
| Comp. Ex. 6 | 3.1 | 6.6 | 4.8 |
| Comp. Ex. 7 | 0.92 | 9.12 | 7.7 |
| Comp. Ex. 8 | 4.5 | 13.3 | 10.4 |

TABLE 3

| | | | | | 0.2-C | 10-C | | |
|---|---|---|---|---|---|---|---|---|
| | | Coating film | | | discharge | discharge | 10-C/0.2-C | |
| | NMP/solid | density | | | capacity | capacity | capacity | Final |
| | content | g/cm³ | Peel test | Smoothness | mAhr/g | mAhr/g | ratio % | evaluation |
| Example 1 | 0.9 | 2.1 | ⊚ | ⊚ | 168 | 150 | 89 | ⊚ |
| Example 2 | 0.84 | 2.2 | ⊚ | ⊚ | 169 | 147 | 87 | ⊚ |
| Example 3 | 0.95 | 2 | ⊚ | ⊚ | 165 | 150 | 91 | ⊚ |
| Example 4 | 0.81 | 2.3 | ⊚ | ⊚ | 168 | 141 | 84 | ◯ |
| Example 5 | 0.78 | 2.3 | ⊚ | ◯ | 168 | 134 | 80 | ◯ |
| Example 6 | 1.02 | 1.9 | ◯ | ⊚ | 161 | 148 | 92 | ◯ |
| Example 7 | 0.95 | 2 | ⊚ | ⊚ | 165 | 152 | 92 | ⊚ |
| Example 8 | 0.87 | 2.2 | ⊚ | ⊚ | 169 | 144 | 85 | ⊚ |
| Example 9 | 1.05 | 1.9 | ◯ | ◯ | 162 | 151 | 93 | ◯ |
| Example 10 | 0.86 | 2.2 | ⊚ | ⊚ | 170 | 139 | 82 | ◯ |
| Example 11 | 0.89 | 2 | ◯ | ◯ | 164 | 143 | 87 | ◯ |
| Example 12 | 0.72 | 2.3 | ⊚ | ◯ | 172 | 131 | 76 | ◯ |
| Comp. Ex. 1 | 0.73 | 2.1 | ◯ | X | 165 | 127 | 77 | X |
| Comp. Ex. 2 | 1.11 | 1.6 | X | ◯ | 153 | 141 | 92 | X |
| Comp. Ex. 3 | 1.19 | 1.8 | X | X | 154 | 145 | 94 | X |
| Comp. Ex. 4 | 0.86 | 2.3 | ⊚ | ⊚ | 170 | 126 | 74 | X |
| Comp. Ex. 5 | 1 | 1.9 | X | X | 156 | 142 | 91 | X |
| Comp. Ex. 6 | 0.71 | 2.4 | ⊚ | ◯ | 172 | 126 | 73 | X |
| Comp. Ex. 7 | 0.93 | 2.3 | ⊚ | ⊚ | 167 | 107 | 64 | X |
| Comp. Ex. 8 | 1.35 | 1.6 | X | X | 149 | 133 | 89 | X |

The above results show that a lithium ion secondary battery containing the lithium-titanium complex oxide proposed by the present invention as an electrode active material offers high initial discharge capacity, excellent rate characteristics, and smooth electrodes.

In the present disclosure where conditions and/or structures are not specified, a skilled artisan in the art can readily provide such conditions and/or structures, in view of the present disclosure, as a matter of routine experimentation. Also, in the present disclosure including the examples described above, any ranges applied in some embodiments may include or exclude the lower and/or upper endpoints, and any values of variables indicated may refer to precise values or approximate values and include equivalents, and may refer to average, median, representative, majority, etc. in some embodiments. Further, in this disclosure, “a” may refer to a species or a genus including multiple species, and “the invention” or “the present invention” may refer to at least one of the embodiments or aspects explicitly, necessarily, or inherently disclosed herein. In this disclosure, any defined meanings do not necessarily exclude ordinary and customary meanings in some embodiments.

The present application claims priority to Japanese Patent Application No. 2011-225158, filed Oct. 12, 2011, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

We/I claim:

1. A lithium-titanium complex oxide, wherein:
(a) an average particle size D50 based on granularity distribution measurement by the laser diffraction method is 0.5 to 1.0 μm;
(b) a maximum particle size D100 based on granularity distribution measurement by the laser diffraction method and a maximum primary particle size d100 measured by observation using a scanning electron microscope have a ratio D100/d100 of 1.5 to 15; and
(c) an equivalent sphere size DBET calculated from a specific surface area measured by the BET method and above D50 have a ratio D50/DBET of 3 to 7.

2. A lithium-titanium complex oxide according to claim 1, whose angle of repose is 35 to 50°.

3. A positive electrode for a battery containing the lithium-titanium complex oxide according to claim 1 as a positive electrode active material.

4. A positive electrode for a battery containing the lithium-titanium complex oxide according to claim 2 as a positive electrode active material.

5. A negative electrode for a battery containing the lithium-titanium complex oxide according to claim 1 as a positive electrode active material.

6. A negative electrode for a battery containing the lithium-titanium complex oxide according to claim 2 as a positive electrode active material.

7. A lithium ion secondary battery having a positive electrode containing the lithium-titanium complex oxide according to claim 1, or a negative electrode containing the lithium-titanium complex oxide according to claim 1.

8. A lithium ion secondary battery having a positive electrode containing the lithium-titanium complex oxide according to claim 2, or a negative electrode containing the lithium-titanium complex oxide according to claim 2.

9. A manufacturing method of lithium-titanium complex oxide whereby a mixture of titanium compound and lithium compound is heat-treated at 700° C. or above to obtain a lithium-titanium complex oxide, after which 100 parts by weight of the obtained lithium-titanium complex oxide is crushed in the presence of 10 parts by weight or less of a liquid dispersion medium to increase the specific surface area of the lithium-titanium complex oxide by 1.0 m²/g or more.

10. A manufacturing method according to claim 9, whereby the specific surface area of the lithium-titanium complex oxide is decreased by 0.5 to 6.0 m²/g by applying heat treatment again after the crushing process.
